(19) United States
(12) Patent Application Publication
(10) Pub. No.: US 2026/0152349 A1
(43) Pub. Date: Jun. 4, 2026

(54) LOGISTICS SYSTEM AND CONTROL METHOD THEREOF

(71) Applicant: HAI ROBOTICS CO., LTD., Shenzhen (CN)

(72) Inventors: Feiyue ZHANG, Shenzhen (CN); Yihua YE, Shenzhen (CN); Xiaolong LI, Shenzhen (CN); Kai CHEN, Shenzhen (CN)

(73) Assignee: HAI ROBOTICS CO., LTD., Shenzhen (CN)

(21) Appl. No.: 19/456,897

(22) Filed: Jan. 22, 2026

Related U.S. Application Data
(63) Continuation of application No. PCT/CN2024/104306, filed on Jul. 8, 2024.

(30) Foreign Application Priority Data
Aug. 3, 2023 (CN) 202310976064.4

(51) Int. Cl. B65G 1/137; B65G 1/04

(52) U.S. Cl. CPC B65G 1/1378; B65G 1/0471

(57) ABSTRACT

A logistics system includes a warehousing apparatus, a picking apparatus, and a carrying apparatus. The warehousing apparatus includes at least one rack, the rack includes a plurality of warehousing layers configured to store material containers, and at least one of the plurality of warehousing layers is a temporary storage layer. The carrying apparatus is configured to transport the material containers between the temporary storage layer and the picking apparatus. The picking apparatus is configured to sort goods in the material containers. The temporary storage layer is located at the bottom portion of the rack. There is a first moving channel under the temporary storage layer for movement of the carrying apparatus. The carrying apparatus is capable of simultaneously bearing and transporting at least two material containers. The at least two material containers carried by the carrying apparatus are stacked in the vertical direction.

### CROSS-REFERENCES

This application is a continuation of International Patent Application No. PCT/CN 2024/104306 filed on Jul. 8, 2024, which claims priority to Chinese Patent Application No. 202310976064.4, filed on Aug. 3, 2023, the disclosures of which are incorporated herein by reference in their entireties.

### TECHNICAL FIELD

This application relates to the field of warehousing and logistics technologies, and in particular, to a logistics system and control method thereof.

### BACKGROUND OF THE DISCLOSURE

A storage method using a three-dimensional warehouse is widely applied in the field of warehouse logistics due to large storage capacity of the three-dimensional warehouse. As artificial intelligence and automation technologies advance, logistics systems continue to achieve higher levels of automation. The three-dimensional warehouse can dock with external equipment through an automated device to implement fully automated retrieving and storing, and transport of goods.

In related technologies, a three-dimensional warehouse typically includes a plurality of racks. Goods retrieving and placing robots may move between these racks. To improve inbound/outbound efficiency, transport robots may be deployed to coordinate with goods retrieving and placing robots. These transport robots may retrieve material containers from racks and transport to external workstations.

However, current transport robots are limited to single-task operations, which requires sequential single-unit retrieval of material containers. This limitation results in low transport efficiency.

### SUMMARY OF THE INVENTION

This application provides a logistics system and a control method thereof to address the technical problem in current logistics systems where transport robots are limited to single-task operations and retrieve material containers one by one, resulting in low transport efficiency.

According to a first aspect, this application provides a logistics system. The logistics system includes a warehousing apparatus, a picking apparatus, and a carrying apparatus. The warehousing apparatus includes at least one rack, the rack includes a plurality of warehousing layers configured to store material containers, and at least one of the plurality of warehousing layers is a temporary storage layer; the carrying apparatus is configured to transport the material containers between the temporary storage layer and the picking apparatus; and the picking apparatus is configured to sort goods in the material containers.

The temporary storage layer is located at the bottom portion of the rack. There is a first moving channel under the temporary storage layer for movement of the carrying apparatus. The carrying apparatus is capable of simultaneously bearing and transporting at least two material containers, and the at least two material containers carried by the carrying apparatus are stacked in a vertical direction.

In the logistics system provided in this application, the carrying apparatus is configured to transport the material container; the racks utilize the temporary storage layer to store material containers that need to be retrieved and deposited; and the carrying apparatus may retrieve a plurality of material containers from the temporary storage layer of the rack at a single time by stacking the material containers. This enables simultaneous transport of the plurality of material containers during a single transport stroke, significantly enhancing material containers transport efficiency.

In some embodiments, the carrying apparatus is configured to retrieve the material containers from the temporary storage layer and simultaneously transport the at least two material containers to the picking apparatus; or retrieve the material containers from the picking apparatus and simultaneously transport the at least two material containers to the temporary storage layer.

In this configuration, during transport tasks, the carrying apparatus may sequentially retrieve a plurality of material containers from the temporary storage layer, or sequentially deposit a plurality of material containers into the temporary storage layer. This achieves an effect of a multi-task operation in a single stroke.

In some embodiments, a height of the first moving channel may be greater than a sum of heights of the carrying apparatus and the material container when the carrying apparatus bears one material container.

In this configuration, after retrieving one material container, the carrying apparatus can still move freely in the first moving channel, so that the carrying apparatus moves to another position on the temporary storage layer to carry a second material container.

In some embodiments, the rack may include a plurality of columns extending in a vertical direction and a plurality of beams extending in a horizontal direction. The beams are connected to the columns, and the columns and the beams collectively form the plurality of warehousing layers arranged in the vertical direction.

The rack may further include a plurality of suspension connectors connected to the beams at a top portion of the temporary storage layer, and the plurality of suspension connectors are spaced at an interval along a length direction of the rack. A temporary storage position is formed between two adjacent suspension connectors, with each position capable of storing at least one material container, and a material container in the temporary storage position may be suspended at the suspension connector.

In this configuration, the material container may be stored in the temporary storage position in a suspended manner, so that the space below the material container is not blocked, and the carrying apparatus can carry a plurality of material containers during retrieving and depositing operations.

In some embodiments, the suspension connector may include a connection portion and a hook portion, where the connection portion has a first end connected to the beams at the top portion of the temporary storage layer and a second end extending away from the beams, and the hook portion can be connected to the second end of the connection portion. The material container may be provided with a sliding groove at a top edge of the material container, and the hook portion may detachably engage with the sliding groove.

In this configuration, stability of the material containers deposited on the temporary storage layer is enhanced while interference occurred between the material containers and the rack during the carrying apparatus retrieve and deposit material containers operations is prevented.

In some embodiments, the carrying apparatus may include a movable base, a lifting mechanism, and a bearing carrier. The lifting mechanism may be disposed on the movable base, the bearing carrier can be connected to the lifting mechanism, and the lifting mechanism is configured to drive the bearing carrier to ascend or descend in the vertical direction. The bearing carrier is configured to bear material containers.

In this configuration, the carrying apparatus maintains minimal occupied volume when the carrying apparatus retrieves and deposits material containers, optimizing spatial utilization and simplifying movement path planning of the carrying apparatus.

In some embodiments, when the carrying apparatus retrieves the material containers from the temporary storage layer, the lifting mechanism may drive the bearing carrier to ascend, so that the bearing carrier abuts against the bottom wall of the material containers on the temporary storage layer, or a top surface of the material container already placed on the bearing carrier abuts against the bottom wall of the material containers on the temporary storage layer, to lift the material container on the temporary storage layer and disengage the material container from the suspension connector.

When the carrying apparatus places the material containers on the temporary storage layer, the lifting mechanism may drive the bearing carrier to descend, so that the material containers placed on the bearing carrier descends and engages with the suspension connector of the temporary storage layer.

In this configuration, ascending or descending of the bearing carrier enables the material containers to be retrieved and deposited on the temporary storage layer, significantly enhancing material container retrieving and depositing efficiency.

In some embodiments, the picking apparatus may include a conveyor and a splitting mechanism, where the conveyor has an input port and an output port, the carrying apparatus may dock with the input port and deposit at least two material containers on the conveyor; or the carrying apparatus may dock with the output port and retrieve the at least two material containers from the conveyor.

The splitting mechanism is configured to split the at least two material containers that are stacked to be arranged along a conveying direction of the conveyor, or stack the at least two material containers that are arranged along the conveying direction of the conveyor.

In this configuration, the picking apparatus may facilitate sequential single-unit transport of material containers, optimizing goods sorting operations in the material containers.

In some embodiments, the conveyor includes an input section, a sorting section, and an output section, where the input section and the output section are connected to two ends of the sorting section respectively; and there are at least two splitting mechanisms, where the splitting mechanisms are disposed on both the input section and the output section.

In this configuration, stacked material containers are separated before the material containers are sorted, and material containers are stacked after the material containers are sorted, thereby improving the input and output efficiency of an entire sorting process of the material containers.

In some embodiments, the splitting mechanism may include a box and a lifting mechanism, where the box is disposed above the conveyor and defines a lifting passage above the conveyor, and the lifting mechanism is movably disposed on an inner wall of the box. The lifting mechanism is configured to drive the material container that enters the lifting passage to ascend or descend in the vertical direction.

In this configuration, operation efficiency is enhanced for both splitting and stacking a plurality of material containers.

In some embodiments, the picking apparatus may include a conveyor, an input bracket, and an output bracket, where the conveyor has an input port and an output port, the input bracket is disposed at the input port, and the output bracket is disposed at the output port.

The carrying apparatus may dock with the input bracket and sequentially deposit at least two material containers into the input bracket; or the carrying apparatus may dock with the output bracket and sequentially retrieve the at least two material containers from the input bracket.

In this configuration, the input bracket and the output bracket enable the sequential deposit of material containers on the conveyor and the sequential retrieving of material containers from the conveyor.

In some embodiments, the input bracket may include two first guide members, the two first guide members are disposed parallel to each other on opposite sides of the input port, and the first guide members are inclined relative to the horizontal direction; the output bracket includes two second guide members, the two second guide members are disposed parallel to each other on opposite sides of the output port, and the second guide members are inclined relative to the horizontal direction; An inclination direction of the first guide members is opposite to an inclination direction of the second guide members.

In this configuration, material containers may automatically slide onto the conveyor at the input port, and automatically slide out of the conveyor at the output port, thereby improving smoothness of deposit and retrieval of the material containers.

According to a second aspect, this application provides a logistics system control method, which is applied to the logistics system in the foregoing technical solution. The method includes:
determining positions of two target material containers at a temporary storage layer of a rack;
controlling a carrying apparatus to sequentially retrieve the two target material containers; and
controlling the carrying apparatus to simultaneously transport the two target material containers to a picking apparatus.

In some embodiments, the controlling a carrying apparatus to sequentially retrieve the two target material containers specifically includes:
controlling the carrying apparatus in a no-load state to move to a first temporary storage position in which a first target material container is located;
controlling the carrying apparatus to lift the first target material container by a first distance;
controlling the carrying apparatus to move to a second temporary storage position in which a second target material container is located, so that the second target material container is located above the first target material container; and
controlling the carrying apparatus to lift the first target material container, so that a top surface of the first target material container abuts against a bottom wall of the second target material container, and driving the second target material container to ascend by a second distance.

In some embodiments, after the controlling the carrying apparatus to simultaneously transport the two target material containers to a picking apparatus, the method further includes:
controlling the picking apparatus to sort goods in the target material containers; and
controlling the carrying apparatus to retrieve two sorted material containers from the picking apparatus and transport the two sorted material containers to the temporary storage layer of the rack.

In some embodiments, the controlling the carrying apparatus to retrieve two sorted material containers from the picking apparatus and transport the two sorted material containers to the temporary storage layer of the rack specifically includes:
controlling the carrying apparatus to transport a first sorted material container to a first control temporary storage position; and
controlling the carrying apparatus to transport a second sorted material container to a second control temporary storage position; where the first sorted material container is vertically stacked above the second sorted material container.

This application provides a logistics system and a control method thereof. The logistics system includes a warehousing apparatus, a picking apparatus, and a carrying apparatus. The warehousing apparatus includes at least one rack including a plurality of warehousing layers configured to store material containers, and at least one of the plurality of warehousing layers is a temporary storage layer; the carrying apparatus is configured to transport the material containers between a temporary storage layer and a picking apparatus; and the picking apparatus is configured to sort the goods in the material containers. The temporary storage layer is located at the bottom portion of the rack, and there is a first moving channel under the temporary storage layer for movement of the carrying apparatus. The carrying apparatus is capable of simultaneously bearing and transporting at least two material containers. The at least two material containers carried by the carrying apparatus are stacked in the vertical direction. Therefore, the carrying apparatus may transport a plurality of material containers during a single transport stroke, which significantly enhances the transport efficiency of the material containers.

In addition to the technical problems resolved through the embodiments of this application described above, the technical features constituting the technical solutions, and the beneficial effects brought about by the technical features of these technical solutions, other technical problems that can be resolved through the logistics system and control method thereof provided in the embodiments of this application, other technical features included in the technical solutions, and the beneficial effects brought about by these technical features are to be further described in detail in detailed description.

### BRIEF DESCRIPTION OF THE DISCLOSURE

To describe the technical solutions of the embodiments of this application or the related art more clearly, the accompanying drawings required for describing the embodiments or the related art are briefly introduced below. Apparently, the accompanying drawings in the following descriptions show some embodiments of this application, and a person of ordinary skill in the art may still derive other drawings from these accompanying drawings without creative efforts.

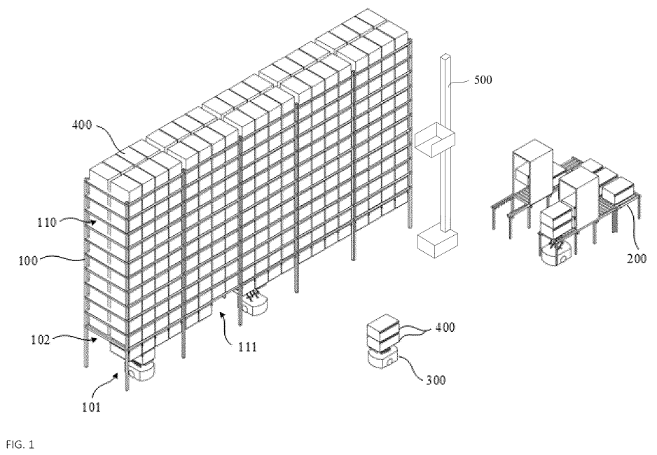

FIG. 1 is a schematic structural diagram of a logistics system according to an embodiment of this application;

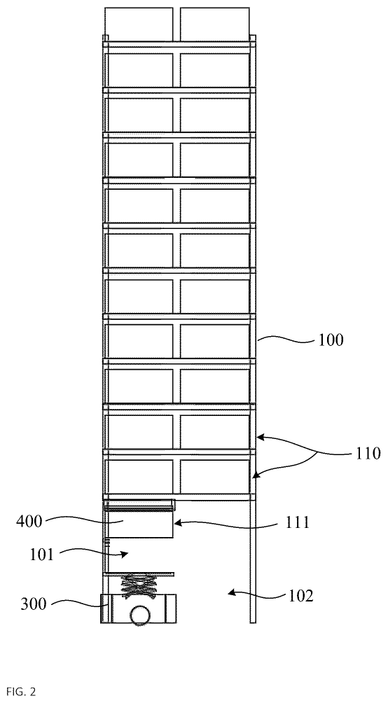

FIG. 2 is a side view of a rack in a logistics system according to an embodiment of this application;

FIG. 3 is a front view of a rack in a logistics system according to an embodiment of this application;

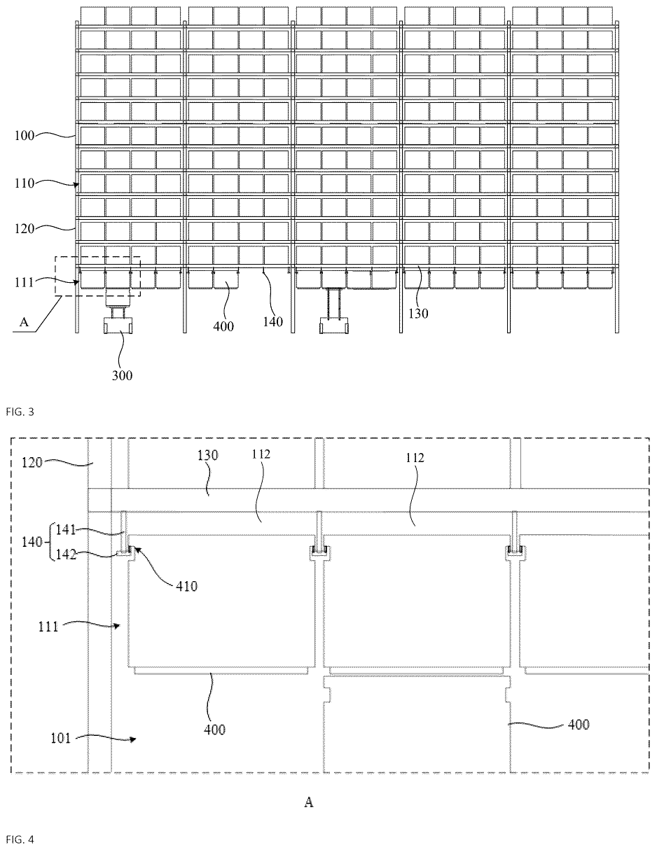

FIG. 4 is a partial view of a position A in FIG. 3;

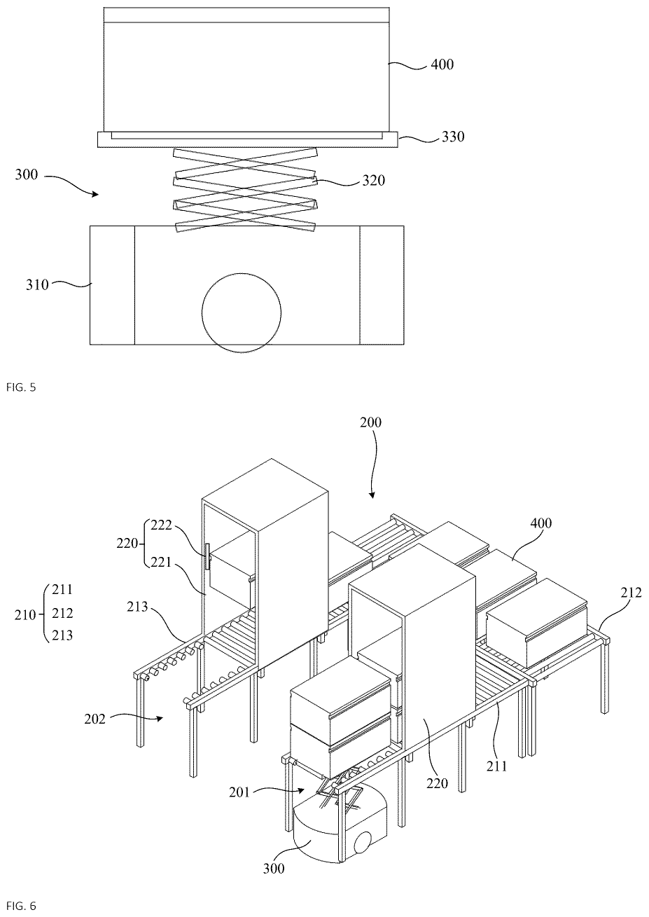

FIG. 5 is a schematic structural diagram of a carrying apparatus in a logistics system according to an embodiment of this application;

FIG. 6 is a first schematic structural diagram of a picking apparatus in a logistics system according to an embodiment of this application;

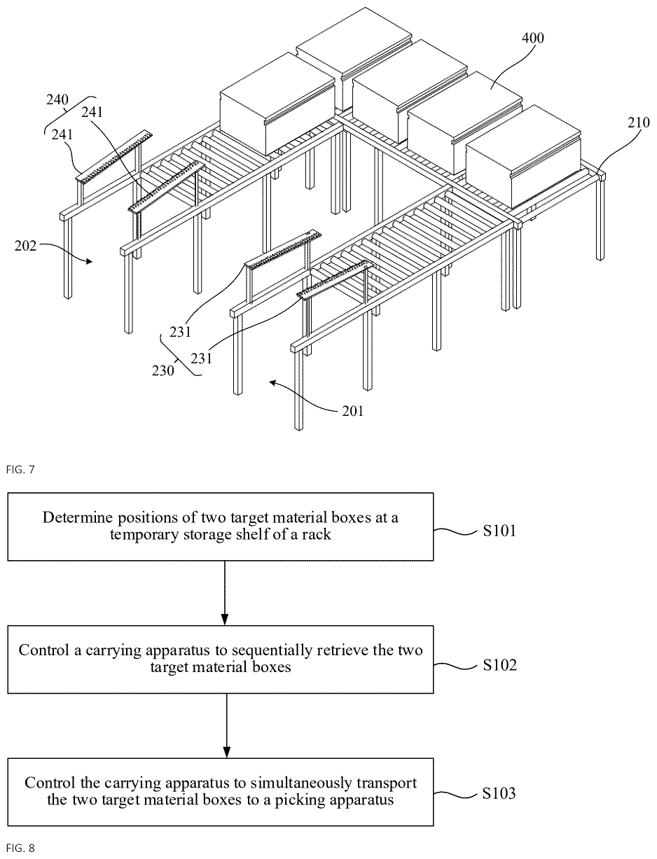

FIG. 7 is a second schematic structural diagram of a picking apparatus in a logistics system according to an embodiment of this application;

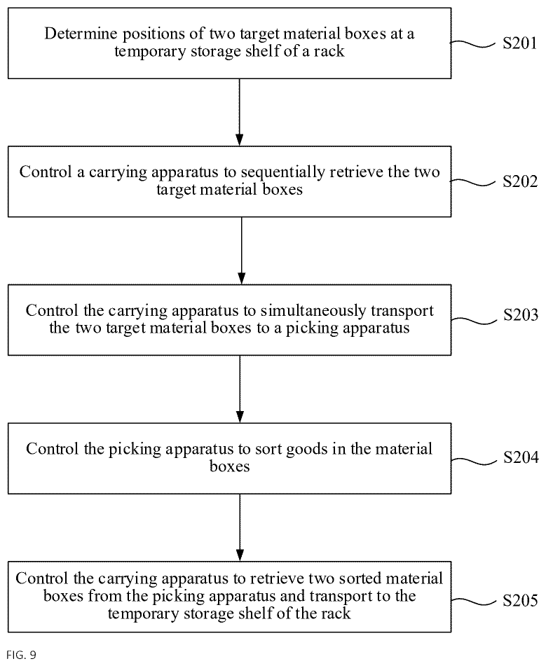

FIG. 8 is a flowchart of a first logistics system control method according to an embodiment of this application; and

FIG. 9 is a flowchart of a second logistics system control method according to an embodiment of this application.

### DESCRIPTION OF THE REFERENCE SIGNS

100—rack; 101—first moving channel; 102—second moving channel; 110—warehousing layer; 111—temporary storage layer; 112—temporary storage position; 120—column; 130—beam; 140—suspension connector; 141—connection portion; 142—hook portion;
200—picking apparatus; 201—input port; 202—output port; 210—conveyor; 211—input section; 212—sorting section; 213—output section; 220—splitting mechanism; 221—box; 222—lifting mechanism; 230—input bracket; 231—first guide member; 240—output bracket; 241—second guide member;
300—carrying apparatus; 310—movable base; 320—lifting mechanism; 330—bearing carrier;
400—material container; and 410—sliding groove; and
500—goods retrieving and depositing robots.

### DETAILED DESCRIPTION

In order to make objectives, technical solutions, and advantages of embodiments of this application clearer, the technical solutions in the embodiments of this application are to be clearly and completely described below with reference to the accompanying drawings in the embodiments of this application. Apparently, the embodiments to be described are a part rather than all of the embodiments of this application. All other embodiments obtained by a person of ordinary skill in the art based on the embodiments of this application without creative efforts shall fall within the protection scope of this application.

First, it should be understood by a person skilled in the art that these implementations are merely used for explaining the technical principles of this application, and are not intended to limit the protection scope of this application. A person skilled in the art may make corresponding adjustment to the implementations as required to adapt to specific application scenarios.

Next, it should be noted that, in the description of this application, directions or position relationships indicated by the terms such as “up”, “down”, “left”, “right”, “front”, “rear”, “inside”, and “outside” are based on direction or position relationships shown in the accompanying drawings, and are merely used for ease of description, rather than indicating or implying that the apparatus or component needs to have a particular orientation or be constructed and operated in a particular orientation. Therefore, such terms should not be construed as a limitation on this application.

Moreover, it should also be noted that, in the description of this application, it should be noted that unless otherwise explicitly specified or defined, the terms such as “connect”, and “connection” should be understood in a broad sense. For example, the connection may be a fixed connection, a detachable connection, or an integral connection; or the connection may be a mechanical connection or an electrical connection; or the connection may be an internal communication between two members. A person of ordinary skill in the art may understand the specific meanings of the foregoing terms in this application according to specific situations.

In descriptions of this specification, descriptions with reference to terms such as “an embodiment”, “some embodiments”, “exemplary embodiments”, “examples”, “specific examples”, or “some examples” mean that a specific feature, structure, material, or characteristic described with reference to the embodiment or example is included in at least one embodiment or example of the present disclosure. In this specification, schematic descriptions of the foregoing terms do not necessarily refer to a same embodiment or example. In addition, the described specific features, structures, materials, or characteristics may be combined in a proper manner in any one or more of the embodiments or examples.

A three-dimensional warehouse, owing to its substantial storage capacity, is extensively employed in the field of warehousing logistics. The three-dimensional warehouse typically includes a plurality of racks. Goods retrieving and depositing robots may move between the racks to handle goods. During outbound of goods, the robots retrieve material containers containing goods from designated storage positions, transport the material containers along a predetermined track path to a sorting workstation for sorting operations, and then the sorted goods are packed for outbound. To enhance inbound/outbound efficiency, in current logistics systems, dedicated transport robots are usually disposed to cooperate with goods retrieving and depositing robots. The transport robots occupy little space and may retrieve outbound material containers from the rack to external workstations.

However, current transport robots have limited transport capabilities. When docking with the rack, the robot can retrieve only a single material container and only perform single-task operations. When the robot travels between the rack and the external workstation, the robot can only transport material containers one by one. This results in low transport efficiency. Consequently, automation costs are high and high-throughput warehousing demands cannot be met.

To address the above issues, embodiments of this application provide a logistics system and a control method thereof. In the logistics system, a carrying apparatus is disposed to retrieve and transport material containers. In cooperation with the storage structure of rack, the carrying apparatus may bear a plurality of material containers in a stacked form during a single transport stroke. This achieves an effect of a multi-task operation in the single stroke, thereby enhancing transport efficiency, reducing automation costs, and meeting the high-throughput warehousing demands in the logistics system.

For convenience of understanding, application scenarios to which the embodiments of this application are applicable are first described below.

The logistics system according to an embodiment of this application can be applied to different fields such as inbound or outbound operations for inventory products in manufacturing plants, retail inventory products, and express sorting in e-commerce logistics. The logistics system involved transport and inbound/outbound operations may include industrial components, electronic parts or products, pharmaceuticals, apparel accessories, food, books, etc. As used herein, “goods” may refer to the aforementioned products themselves or to material containers or trays containing these products. This is not specifically limited in this embodiment of this application. Throughout the following description, a “material container” is used to refer to a target of inbound/outbound operations.

FIG. 1 is a schematic structural diagram of a logistics system according to an embodiment of this application, and FIG. 2 is a side view of a rack in a logistics system according to an embodiment of this application.

Referring to FIG. 1 and FIG. 2, this application provides a logistics system. The logistic system includes a warehousing apparatus, a picking apparatus 200, and a carrying apparatus 300. The warehousing apparatus includes at least one rack 100, the rack 100 includes a plurality of warehousing layers 110, the warehousing layers 110 are configured to store material containers 400. At least one of the plurality of warehousing layers 110 is a temporary storage layer 111. During inbound or outbound operations of the material containers 400, the temporary storage layer 111 is configured to store the material containers 400 temporarily. The picking apparatus 200 may sort the goods in the material containers 400. The carrying apparatus 300 may transport the material containers 400 between the temporary storage layer 111 and the picking apparatus 200.

The temporary storage layer 111 is located at the bottom portion of the racks 100, and there is a first moving channel 101 under the temporary storage layer 111 for movement of the carrying apparatus 300. The carrying apparatus 300 is capable of simultaneously bearing and transporting at least two material containers 400, and the at least two material containers 400 carried by the carrying apparatus 300 are stacked in the vertical direction.

It should be understood that, the carrying apparatus 300 has a compact volume and occupies little space to move under the rack 100. The carrying apparatus 300 in the first moving channel 101 may sequentially retrieve at least two material containers 400 from the temporary storage layer 111. The retrieved material containers 400 are stacked from bottom to top on the carrying apparatus 300 according to the retrieval sequence. Thus, during transport of the material containers 400 between the racks 100 and the picking apparatus 200, the carrying apparatus 300 may transport up to two or more than two material containers 400 in a single stroke.

It should be noted that, in the logistics system according to an embodiment of this application, the material containers 400 requiring outbound operations on the racks 100 and newly inbound material containers 400 are both stored on the temporary storage layer 111. A plurality of warehousing layers 110 of the racks 100 are arranged in the vertical direction, while the temporary storage layer 111 is located at the lowest level of the racks 100. This facilitates the docking of the carrying apparatus 300 moving in the first moving channel 101 with the temporary storage layer 111. By stacking the material containers 400, the carrying apparatus 300 retrieves a plurality of material containers 400 from the temporary storage layer 111 of the racks 100 at a single time, enabling the transport of the plurality of material containers 400 during a single transport stroke. This enhances the material containers 400 transport efficiency.

In addition, due to increased transport capacity per carrying apparatus 300, the logistics system may accommodate higher warehouse throughput. Even during peak order periods, the material containers 400 transport tasks can be effectively completed. Additionally, in preset application scenarios of the logistics system, the number of deployed carrying apparatuses 300 can be reduced, so that movement path planning for the carrying apparatus 300 is simplified, spatial layout optimization of the logistics system is facilitated, and automation costs are effectively lowered.

In some embodiments, the carrying apparatus 300 is configured to retrieve material containers 400 from the temporary storage layer 111 and simultaneously transport at least two material containers 400 to the picking apparatus 200, the carrying apparatus 300 is configured to retrieve material containers 400 from the picking apparatus 200 and simultaneously transport at least two material containers 400 to the temporary storage layer 111.

It should be understood that during transport operations, the carrying apparatus 300 may sequentially retrieve a plurality of material containers 400 from the temporary storage layer 111 and transport the retrieved plurality of material containers 400 to the picking apparatus 200 for goods sorting at a single time. Each material container 400 may correspond to a different order task. Alternatively, the carrying apparatus 300 may retrieve a plurality of material containers 400 from the picking apparatus 200 and transport the retrieved plurality of material containers 400 to the racks 100 at a single time, then sequentially place the plurality of material containers 400 into the temporary storage layer 111. This achieves an effect of a multi-task operation in a single stroke.

In this embodiment of this application, because the carrying apparatus 300 may transport a plurality of material containers 400 during a single transport stroke, the carrying apparatus 300, after retrieving a first material container 400, needs to be able to move freely in the first moving channel 101. A height of the first moving channel 101 may be greater than a sum of heights of the carrying apparatus 300 and a material container 400 when the carrying apparatus 300 bears one material container 400, thereby enabling the carrying apparatus 300 to move to another position of the temporary storage layer 111 for subsequent retrieval of the second material container 400. This prevents interference between the material containers 400 on the carrying apparatus 300 and either the material containers 400 on the temporary storage layer 111 or the racks 100.

It should be noted that, an upper limit of the number of material containers 400 retrieved by the carrying apparatus 300 per single work may be two, three, or more than three. This is not specifically limited in this embodiment of this application. For example, it is assumed that an upper limit of material containers 400 per retrieval operation by the carrying apparatus 300 is two, the height of the first moving channel 101 may correspond to the height of the carrying apparatus 300 when bearing one material container 400. For example, the height of the first moving channel 101 may be slightly greater than the height of the carrying apparatus 300 when bearing one material container 400. This configuration facilitates passage of the carrying apparatus 300 while optimizing spatial utilization.

The following describes a specific structure of the racks 100, a storage method of the material containers 400 on the temporary storage layer 111, and the operation method of the carrying apparatus 300 to retrieve and deposit the material containers 400 on the temporary storage layer 111 in detail.

FIG. 3 is a front view of a rack in a logistics system according to an embodiment of this application, and FIG. 4 is a partial view of a position A in FIG. 3.

Referring to FIG. 1 to FIG. 4, in some embodiments, the rack 100 may include a plurality of columns 120 extending in the vertical direction and a plurality of beams 130 extending in the horizontal direction; the beams 130 are connected to the columns 120, and the columns 120 and the beams 130 collectively form a plurality of warehousing layers 110 arranged in the vertical direction.

The height direction of the racks 100 is defined as the X direction, and the length direction of the racks 100 is defined as the Y direction. The columns 120 extend along the X direction, and each warehousing layer 110 may store a plurality of material containers 400 along the Y direction.

It should be understood that the racks 100 may further include a plurality of suspension connectors 140 connected to the beams 130 at the top portion of the temporary storage layer 111, and the plurality of suspension connectors 140 are spaced at an interval along the length direction of the racks 100. A temporary storage position is formed between two adjacent suspension connectors 140, with each position capable of storing at least one material container 400, and material containers 400 in temporary storage positions may be suspended at the suspension connectors 140. In this configuration, the material containers 400 may be stored in the temporary storage position in a suspended manner, while the space below the material containers 400 is not blocked. This facilitates retrieval of a plurality of material containers 400 by the carrying apparatus 300 when the carrying apparatus 300 performs retrieving and depositing operations.

It should be noted that, an upper edge of the temporary storage layer 111 is a lower edge of the beams 130 of the warehousing layer 110 above the temporary storage layer 111, while a lower portion of the temporary storage layer 111 maintains a suspended configuration. Specifically, no beam 130 is installed beneath the temporary storage layer 111. This enables the carrying apparatus 300 to access the first moving channel 101 for retrieving and depositing the material containers 400, while preventing interference between the carrying apparatus 300 with the carried material containers 400 and the racks 100.

In some embodiments, the suspension connector 140 may include a connection portion 141 and a hook portion 142, where the connection portion 141 has a first end connected to the beams 130 at the top portion of the temporary storage layer 111 and a second end extending away from the beams 130, and the hook portion 142 is capable of connecting to the second end of the connection portion 141; and the material container 400 may be provided with a sliding groove 410 at its top edge, and the hook portion 142 may detachably engage with the sliding groove 410.

It should be understood that, a temporary storage position 112 is formed between two adjacent suspension connectors 140 along the Y direction. For centrally positioned suspension connectors 140 on the racks 100 along the Y direction, each suspension connector 140 interfaces with two adjacent temporary storage positions 112 on both sides. Each connection portion 141 may have hook portions 142 attached on both sides. The hook portions 142 flanking each temporary storage position 112 feature an inward bend toward the temporary storage position 112 relative to the connection portion 141. This configuration enables the frame edges of the material containers 400 to engage with the hook portions 142.

Exemplarily, the material containers 400 may have a tapered structure with a wider top and a narrower bottom, that is, a vertical projection of the top surface of the material containers 400 slightly exceeds and fully covers that of the bottom surface. This configuration enables the bottom surface of an upper material container 400 to rest securely on the stepped surface of a lower material container 400 during vertical stacking of a plurality of material containers 400, thereby enhancing stacking reliability of the material containers 400 while facilitating retrieval of a plurality of material containers 400 by the carrying apparatus 300.

It should be noted that, the top edge of the material containers 400 may be provided with a flanged edge, with its underside that faces the bottom of the material containers 400 forming a sliding groove 410. When the material containers 400 are mounted on the suspension connectors 140, the hook portion 142 engages below the sliding groove 410, to provide vertical support for the material containers 400, thereby improving depositing stability of the material containers 400 on the temporary storage layer 111. During retrieval of the material containers 400, the carrying apparatus 300 may lift the material containers 400 upward to disengage the sliding groove 410 of the material containers 400 from the hook portion 142. This prevents interference between the material containers 400 and the racks 100 during retrieving and depositing material containers 400 by the carrying apparatus 300.

The following describes a specific structure of the carrying apparatus 300 in detail.

FIG. 5 is a schematic structural diagram of a carrying apparatus in a logistics system according to an embodiment of this application.

Referring to FIG. 5, and with reference to FIG. 1 to FIG. 4, in some embodiments, the carrying apparatus 300 may include a movable base 310, a lifting mechanism 320 capable of mounting on the movable base 310, and a bearing carrier 330 capable of connecting to the lifting mechanism 320, in which the lifting mechanism 320 is configured to drive the bearing carrier 330 to move up or down in the vertical direction; and the bearing carrier 330 is configured to bear the material containers 400. This configuration facilitates taking and placing material containers 400 operations by the carrying apparatus 300, while ensuring minimal occupied volume, optimizing spatial utilization. Furthermore, the minimized spatial occupancy of the carrying apparatus 300 simplifies movement path planning when the carrying apparatus 300 moves in the warehouse.

It should be understood that, when the carrying apparatus 300 retrieves the material containers 400 from the temporary storage layer 111, the lifting mechanism 320 may drive the bearing carrier 330 to lift. When the carrying apparatus 300 is unloaded, the bearing carrier 330 abuts against the bottom wall of the material containers 400 on the temporary storage layer 111. The ascent of the bearing carrier 330 drives the material containers 400 on the temporary storage layer 111 to lift and disengage the material containers 400 from the suspension connectors 140, enabling the carrying apparatus 300 to exit the first moving channel 101 before lowering the bearing carrier 330 to complete the taking and placing operations of the material containers 400.

In addition, when the carrying apparatus 300 already bears one material container 400, ascent of the bearing carrier 330 causes the top surface of the material containers 400 placed on the bearing carrier 330 to abut against the bottom wall of the material container 400 on the temporary storage layer 111. This lifts the upper material container 400 on the temporary storage layer 111 by the lower material container 400, thereby lifting the material containers 400 on the temporary storage layer 111 to disengage them from the suspension connector 140. Subsequently, the carrying apparatus 300 exits from the first moving channel 101 and accomplishes dual-material container 400 retrieval, resulting in two stacked material containers 400 on the bearing carrier 330.

It should be noted that, when the carrying apparatus 300 retrieves the material containers 400 from the picking apparatus 200 and deposits the material containers 400 on the temporary storage layer 111, the carrying apparatus 300 may lift the material containers 400 that needs to be deposited above the hook portion 142 of the target temporary storage layer 111 via the lifting mechanism. Then, the lifting mechanism 320 drives the bearing carrier 330 to descend, so that the material container 400 on the bearing carrier 330 descends and is mounted on suspension connector 140 of the temporary storage layer 111, to complete the storage operation of the material containers 400 on the temporary storage layer, enhancing retrieving and depositing efficiency of the material containers 400.

For example, the lifting mechanism 320 may be a hydraulic jack, which is driven by hydraulic pump for ascending and descending of the bearing carrier 330. Alternatively, the lifting mechanism 320 may have a multi-link hinge structure, in which multiple hinged links form a scissors-like mechanism. Convergent rotation of two hinged links enables the bearing carrier 330 to ascend, while divergent rotation of two hinged links enables the bearing carrier 330 to descend.

In addition, the bearing carrier 330 may have a tray-type or planer structure. The shapes or dimensions of the bearing carrier 330 are not specifically limited in this embodiment of this application.

In this embodiment of this application, because the carrying apparatus 300 may transport two or more than two material containers 400 to the picking apparatus 200 at a single time, the picking apparatus 200 needs to receive a plurality of stacked material containers 400 for goods sorting operations. The following describes the structure of the picking apparatus 200 in detail by using different specific implementations.

FIG. 6 is the first schematic structural diagram of a picking apparatus in a logistics system according to an embodiment of this application.

Referring to FIG. 6, and with reference to FIG. 1 to FIG. 4, in a first implementation, the picking apparatus 200 may include a conveyor 210 and a splitting mechanism 220, where the conveyor 210 has an input port 201 and an output port 202. The carrying apparatus 300 may dock with the input port 201 and deposit at least two material containers 400 on the conveyor 210; or the carrying apparatus 300 may dock with the output port 202 and retrieve the at least two material containers 400 from the conveyor 210.

The splitting mechanism 220 is configured to split the at least two stacked material containers 400 to be arranged along the conveying direction of the conveyor 210, or stack the at least two material containers 400 arranged along the conveying direction of the conveyor 210. In this configuration, the picking apparatus 200 may implement sequential single-unit transport of material containers 400, facilitating goods sorting operations on the material containers 400.

It may be understood that the splitting mechanism 220 drives the material containers 400 to move in the vertical direction, to split the stacked material containers 400 into horizontal arrangement, or stacks the material containers 400 arranged in the horizontal direction.

Exemplarily, when two stacked material containers 400 enter the splitting mechanism 220 through the conveyor 210, the splitting mechanism 220 lifts the upper material container 400 to separate the two material containers 400. The lower material container 400 advances out of the splitting mechanism 220 along the conveyor 210 while the lifted material container 400 subsequently descends to rejoin the conveyor 210 under the action of the splitting mechanism 220, thus enabling in-tandem transport of the two material containers 400 along the conveyor 210. The operation of stacking two material containers 400 by the splitting mechanism 220 is a reverse process of the splitting operation, and details are not described herein.

In some embodiments, the conveyor 210 includes an input section 211, a sorting section 212, and an output section 213, where the input section 211 and the output section 213 are connected to two ends of the sorting section 212 respectively. At least two splitting mechanisms 220 are provided, and the splitting mechanisms 220 are mounted on both the input section 211 and the output section 213. In this configuration, stacked material containers 400 are split before sorting and restacked after sorting, thereby improving the input and output efficiency of an entire sorting process of the material containers 400.

It should be understood that, the splitting mechanism 220 of the input section 211 is responsible for splitting the plurality of stacked material containers 400 into horizontal arrangement, and the splitting mechanism 220 of the output section 213 is responsible for stacking the sorted material containers 400 in the vertical direction. This facilitates the carrying apparatus 300 to perform retrieving.

Exemplarily, the input section 211, the sorting section 212, and the output section 213 may be sequentially connected, and have a “U” shape. The length and height dimensions of the input section 211, the sorting section 212, and the output section 213 are not specifically limited in this embodiment of this application.

It should be noted that, Both the input port 201 and the output port 202 may feature double-bar shaped docking ports. At the input port 201 and the output port 202, frame edges along two sides of the conveyor 210 support the material containers 400, with rollers integrated along the inner surfaces of the frame edges to enable seamless deposit of the material containers 400 from the docking ports to the inside of the conveyor 210, and retrieval from the inside of the conveyor 210 to the docking ports. The vacant central zone of these docking ports prevents interference between the carrying apparatus 300 and the conveyor 210 when the carrying apparatus 300 retrieves and deposits the material containers 400 through lifting and lowering.

In some embodiments, a sorting position may be provided on a side of the sorting section 212, allowing manual sorting of goods in the material container 400 by workers. Alternatively, a sorting robot may be disposed on a side of the sorting section 212 to perform automated sorting. This is not specifically limited in this embodiment of this application.

The sorting robot may be provided with a detection unit, where the detection unit is configured to identify goods information in the material containers 400 on the conveyor 210, thereby enhancing accuracy of sorting the goods in the material containers 400.

For example, the detection units may include, but are not limited to, 3D cameras, radars, code readers, laser sensors, and the like. The detection unit may include one or more of the foregoing sensing units, which is not specifically limited in this embodiment of this application.

In some embodiments, the splitting mechanism 220 may include a box 221 and a lifting mechanism 222, where the box is located above the conveyor 210, defining a lifting passage over the conveyor 210, and the lifting mechanism 222 is movably disposed on an inner wall of the box 221. The lifting mechanism 222 is configured to drive the material containers 400 that enters the lifting passage to ascend or descend in the vertical direction. In this configuration, operation efficiency is enhanced for both splitting and stacking a plurality of material containers 400.

It should be noted that, the box 221 of the splitting mechanism 220 may feature full penetration at both ends along the conveying direction of the conveyor 210, forming a gate-frame-like structure to facilitate passing of the material containers 400. The lifting mechanism 222 may be driven by drive systems, such as synchronous belt transmission or chain transmission. This is not specifically limited in this embodiment of this application.

FIG. 7 is a second schematic structural diagram of a picking apparatus in a logistics system according to an embodiment of this application.

Referring to FIG. 7 and with reference to FIG. 2 to FIG. 4, in a second implementation, the picking apparatus 200 may include a conveyor 210, an input bracket 230, and an output bracket 240, where the conveyor 210 has an input port 201 and an output port 202, the input bracket 230 is located at the input port 201, and the output bracket 240 is located at the output port 202.

The carrying apparatus 300 may dock with the input bracket 230 and sequentially deposit at least two material containers 400 into the input bracket 230; or the carrying apparatus 300 may dock with the output bracket 240 and sequentially retrieve the at least two material containers 400 from the output bracket 240. In this configuration, the input bracket 230 and the output bracket 240 enable the sequential deposit of the material containers 400 into the conveyor 210 and the sequential retrieval of the material containers 400 from the conveyor 210.

It should be understood that, after the carrying apparatus 300 deposits the material containers 400 one by one on the input bracket 230, the input bracket 230 may deposit the material containers 400 one by one into the conveyor 210. The sorted material containers 400 may be deposited into the output bracket 240 along the conveyor 210 one by one, and the carrying apparatus 300 may retrieve the sorted material containers 400 one by one from the output racks 240.

It should be noted that, a structure of the conveyor 210 and a method for goods sorting may be the same as previously described for the picking apparatus 200, and details are not described herein. The following describes only the structures of the input brackets 230 and the output brackets 240 in detail.

In some embodiments, the input bracket 230 may include two first guide members 231 arranged parallel to each other on opposite sides of the input port 201, and the first guide members 231 are inclined relative to the horizontal direction. The output bracket 240 may include two second guide members 241 arranged parallel to each other on opposite sides of the output port 202, and the second guide members 241 are inclined relative to the horizontal direction.

It may be understood that an inclination direction of the first guide members 231 is opposite to that of the second guide members 241. The input bracket 230 is inclined toward the conveyor 210 from the horizontal direction, enabling the material containers 400 placed on the input bracket 230 to automatically slide into the conveyor 210 at the input port 201. Conversely, the output bracket 240 angles away from the conveyor 210 relative to the horizontal direction, with the second guide member's distal end from the conveyor 210 featuring a baffle. And thus the material containers 400 may automatically slide out of the conveyor 210 at the output port 202, thereby improving smoothness of deposit and retrieval of the material containers 400.

In some embodiments, when the carrying apparatus 300 is configured to transport two material containers 400 from the temporary storage layer 111 to the picking apparatus 200, the carrying apparatus 300 will carry the two material containers, and first travel to the input bracket 230, lift the material containers 400 on the carrying apparatus 300 such that the sliding grooves 410 of the upper material containers 400 could be engaged with the first guide members 231. The upper material containers 400 will then slide into the conveyor 210. After the upper material containers 400 slides into the conveyor 210, the carrying apparatus 300 will lift the lower material container 400 on the carrying apparatus 300, such that the sliding grooves 410 of the lower material containers 400 could be engaged with the first guide members 231. The lower material container 400 will then slide into the conveyor 210.

In some embodiments, a material container 400 after being picked by the picking apparatus 200 will be conveyed to an end of the conveyor 210 that connected the output bracket 230. The sliding grooves 410 of the material container 400 will be engaged with the second guide members 241, and then the material container 400 slides to an end of the second guide members 241 that is away from the conveyor 210, the baffle there will stop the material container 400. The carrying apparatus 300 at the output port 202 will lift the material container 400 on the output bracket 230, and carries the material container 400, so as to separate the material container 400 from the output bracket 230. After another material container 400 reaches the output bracket 230, the carrying apparatus 300 will lift the material container 400 carried on the carrying apparatus 300, such that a top the material container 400 contacts a bottom of the another material container 400 and lifts the another material container 400, and the another material container 400 will be stacked on the material container 400, and be separated from the output bracket 230. Then, the carrying apparatus 300 will transport the two material containers 400 stacked thereon to the temporary storage layer 111.

Exemplarily, both the first guide member 231 and the second guide member 241 may utilize a fluency strip, including parallel brackets with a plurality of rollers arranged longitudinally between the brackets. The inclination angles or lengths of the first guide member 231 and the second guide member 241 are not specifically limited in this embodiment of this application.

In this embodiment of this application, the logistics system may further include goods retrieving and depositing robots 500. The goods retrieving and depositing robots 500 may retrieve the material containers 400 requiring inbound operations from the temporary storage layer 111 to the warehousing layer 110 above the temporary storage layer 111. And the goods retrieving and depositing robot 500 may also retrieve the material containers 400 requiring outbound operations from the warehousing layer 110 above the temporary storage layer 111 to the temporary storage layer 111.

It should be understood that, there may be a plurality of racks 100. The plurality of the racks 100 may form a warehousing area, with an aisle formed between two adjacent racks 100 for the goods retrieving and depositing robots 500 to move along the aisle. Since the carrying apparatus 300 may move in the first moving channel 101 at the bottom of the racks 100, when the carrying apparatus 300 operates in the warehousing area of the racks 100, it may utilize the space occupied by the racks 100 without requiring dedicated channels between the racks 100 for the carrying apparatus 300 movement. This configuration also minimizes obstruction to the aisles occupied by goods retrieving and depositing robots 500, thereby enhancing transport efficiency of the carrying apparatus 300.

It should be noted that, in the logistics system provided in this embodiment of this application, the goods retrieving and depositing robots 500 and the carrying apparatus 300 may work in coordination. Specifically, the goods retrieving and depositing robots 500 perform retrieving and depositing operations of the material containers 400 on the racks 100, while the carrying apparatus 300 is responsible for transporting the material containers 400 on the racks 100. This cooperative working method eliminates the need for the relatively large goods retrieving and depositing robots 500 to exit the aisles, thereby optimizing spatial utilization, and preventing apparatus congestion.

In some embodiments, the temporary storage layer 111 may be configured as a single shelf, while the other warehousing layers 110 besides the temporary storage layer 111 may be arranged as a plurality of shelves along the height direction of the racks 100. Furthermore, the racks 100 may further include the second moving channel 102 positioned laterally adjacent to the temporary storage layer 111. A height of the second moving channel 102 may be greater than that of the carrying apparatus 300 when bearing the two material containers 400. This configuration allows for full utilization of the space beneath the racks 100, enabling the carrying apparatus 300 to move in and out of the warehousing area without occupying the aisle space, thereby improving convenience of inbound and outbound operations for the material containers 400.

An embodiment of this application further provides a logistics system control method, which is applied to the logistics system in the foregoing technical solution. FIG. 8 is a flowchart of the first logistics system control method according to an embodiment of this application. As shown in FIG. 8, with reference to FIG. 1 to FIG. 6, the method includes:
S101: Determine positions of two target material containers at a temporary storage layer of a rack.

A control center in the logistics system may distribute order tasks. After receiving the order tasks, goods retrieving and depositing robots first retrieve target material containers corresponding to the order tasks from a warehousing layer 110 above a rack 100 and deposit the target material containers to a temporary storage layer 111. The carrying apparatus 300, based on assigned order information, identifies specific storage positions of the target material containers in the temporary storage layer 111, and accordingly moves beneath the designated temporary storage positions on the corresponding temporary storage layer 111.
S102: Control a carrying apparatus to sequentially retrieve the two target material containers.

It should be understood that, the carrying apparatus 300 in this embodiment of this application is configured to transport two material containers during a single transport stroke. When the two material containers correspond to two separate order tasks, the carrying apparatus 300 may sequentially move beneath two designated temporary storage positions on the temporary storage layer 111 based on the assigned two pieces of order task information, sequentially retrieving both material containers in sequence and stack the two material containers on the carrying apparatus 300. The retrieval process of the carrying apparatus 300 specifically includes the following steps:
Step 1: Control the carrying apparatus 300 in a no-load state to move to a first temporary storage position in which a first target material container is located. This enables the carrying apparatus 300 to abut against the bottom of the first target material container.
Step 2: Control the carrying apparatus 300 to lift the first target material container by a first distance.

The bearing carrier 330 of the carrying apparatus 300 may be driven to lift so that the bearing carrier 330 abuts against the bottom wall of the first target material container, and subsequently lifts the first target material container, where the first distance is a distance that enables the first target material container to be disengaged from the suspension connector 140.
Step 3: Control the carrying apparatus 300 to move to the second temporary storage position containing the second target material container.

After retrieval of the first target material container and removal from the racks 100, the bearing carrier 330 may descend to an initial position, enabling the carrying apparatus 300 to proceed through the first moving channel 101 while carrying the first target material container. The carrying apparatus then moves beneath the second temporary storage position, so that the second target material container is located above the first target material container.
Step 4: Control the carrying apparatus 300 to lift the first target material container, so that a top surface of the first target material container abuts against a bottom wall of the second target material container, and drive the second target material container to ascend by a second distance.

In this configuration, the first target material container and the second target material container are stacked, and the second distance is a distance that enables the second target material container to be disengaged from the suspension connector 140.
S103: Control the carrying apparatus to simultaneously transport the two target material containers to the picking apparatus.

It should be understood that, the logistics system may have a plurality of picking apparatuses 200. After retrieving two target material containers, the carrying apparatus 300 may transport the two target material containers to either a nearest available picking apparatus 200 as allocated by the control center, or an alternative picking apparatus 200 with relatively lighter tasks loads based on real-time operation workload assessment.

An embodiment of this application further provides a second logistics system control method, which is applied to the logistics system in the foregoing technical solution. FIG. 9 is a flowchart of the second logistics system control method according to an embodiment of this application. As shown in FIG. 9, with reference to FIG. 1 to FIG. 6, the method includes:
S201: Determine positions of two target material containers at a temporary storage layer of a rack.

It should be noted that, for an execution process of step S201, refer to the execution process of step S101, and details will not be described herein.
S202: Control a carrying apparatus to sequentially retrieve the two target material containers.

It should be noted that, for an execution process of step S202, refer to the execution process of step S102, and details will not be described herein.
S203: Control the carrying apparatus to simultaneously transport the two target material containers to a picking apparatus.

It should be noted that, for an execution process of step S203, refer to the execution process of step S103, and details will not be described herein.
S204: Control the picking apparatus to sort the goods in the material containers.

The carrying apparatus 300 may deposit two target material containers one by one into the conveyor 210 of the picking apparatus 200, or the carrying apparatus 300 may deposit two target material containers in a stacked configuration into the conveyor 210 simultaneously, and then a splitting mechanism 220 on the conveyor 210 splits the stacked material containers. The picking apparatus 200 may sort goods in the target material containers according to the goods list in the order tasks, and then the sorted material containers are sent away through the conveyor 210.
S205: Control the carrying apparatus to retrieve two sorted material containers from the picking apparatus and transport to the temporary storage layer of the rack.

The carrying apparatus 300 may retrieve two sorted material containers from the picking apparatus 200 and transport the two sorted material containers during a single stroke. After moving to the rack 100, the carrying apparatus 300 may move to a corresponding temporary storage position according to location information of vacant storage positions in the temporary storage layer 111 allocated by the control center, and deposit the two sorted material containers one by one to two temporary storage positions. Specifically, the following steps are included:
Step 1: Control the carrying apparatus 300 to transport a first post-sorting material container to a first control temporary storage position.

It may be understood that the first sorted material container is stacked above the second sorted material container. The carrying apparatus 300 may lift the first sorted material container to a predetermined height to prevent interference with the suspension connector 140 when the first sorted material container enters the first temporary storage position, then the first sorted material container is lowered to engage with the suspension connector 140. Then, the second sorted material container descends to achieves separation between the first sorted material container and the second sorted material container.
Step 2: Control the carrying apparatus 300 to transport the second sorted material container to the second control temporary storage position.

It should be understood that, the carrying apparatus 300 may lift the second sorted material container to a predetermined height to prevent interference with the suspension connector 140 when the second sorted material container enters the second temporary storage position. Then, the second sorted material container is lowered to engage with the suspension connector 140.

Finally, it is to be noted that the foregoing embodiments are merely used for describing the technical solutions of this application, but are not intended to limit this application. Although the present disclosure is described in detail with reference to the foregoing embodiments, a person of ordinary skill in the art is to understand that, modifications may still be made to the technical solutions in the foregoing embodiments, or equivalent replacements may be made to some or all of the technical features; However, these modifications or replacements do not cause the essence of corresponding technical solutions to depart from the scope of the technical solutions in the embodiments of this application.

1. A logistics system, comprising: a warehousing apparatus, a picking apparatus, and a carrying apparatus, wherein the warehousing apparatus comprises at least one rack comprising a plurality of warehousing layers configured to store a material container, and at least one of the plurality of warehousing layers is a temporary storage layer; wherein the carrying apparatus is configured to transport the material container between the temporary storage layer and the picking apparatus; and wherein the picking apparatus is configured to sort goods that are in the material container;
wherein the temporary storage layer is located at a bottom portion of the at least one rack, there is a first moving channel under the temporary storage layer for movement of the carrying apparatus, the carrying apparatus is capable of simultaneously bearing and transporting at least two material containers, and the at least two material containers carried by the carrying apparatus are stacked in a vertical direction.

2. The logistics system according to claim 1, wherein the carrying apparatus is configured to retrieve the at least two material containers from the temporary storage layer and then transport the at least two material containers to the picking apparatus; or
the carrying apparatus is configured to retrieve the at least two material containers from the picking apparatus and then transport the at least two material containers to the temporary storage layer.

3. The logistics system according to claim 1, wherein a height of the first moving channel is greater than a sum of heights of the carrying apparatus and the material container when the carrying apparatus bears one material container.

4. The logistics system according to claim 1, wherein the at least one rack comprises a plurality of columns extending in a vertical direction and a plurality of beams extending in a horizontal direction; wherein the beams are connected to the columns, the columns and the beams collectively form the plurality of warehousing layers, and the plurality of warehousing layers are arranged in the vertical direction; and
wherein the at least one rack further comprises a plurality of suspension connectors, and the plurality of suspension connectors are connected to the beams at a top portion of the temporary storage layer, and the plurality of suspension connectors are spaced at intervals along a length direction of the at least one rack; wherein a temporary storage position is formed between two adjacent suspension connectors, each temporary storage position is capable of storing at least one material container, and the at least one material container in the temporary storage position is suspended on the suspension connector.

5. The logistics system according to claim 4, wherein the suspension connector comprises a connection portion and a hook portion, a first end of the connection portion is connected to the beams at the top portion of the temporary storage layer, a second end of the connection portion extends away from the beams, and a hook portion is connected to the second end of the connection portion; and the material container is provided with a sliding groove at a top edge of the material container, wherein the hook portion detachably engages with the sliding groove.

6. The logistics system according to claim 4, wherein the carrying apparatus comprises a movable base, a lifting mechanism, and a bearing carrier, wherein the lifting mechanism is mounted on the movable base, and the bearing carrier is connected to the lifting mechanism, wherein the lifting mechanism is configured to drive the bearing carrier to move up or down in the vertical direction;
and the bearing carrier is configured to bear the material container.

7. The logistics system according to claim 6, wherein when the carrying apparatus retrieves the material container from the temporary storage layer, the lifting mechanism drives the bearing carrier to ascend, so that the bearing carrier abuts against a bottom wall of the material container on the temporary storage layer or a top surface of the material container placed on the bearing carrier abuts against the bottom wall of the material containers on the temporary storage layer, to lift the material container on the temporary storage layer and disengage the material container from the suspension connector; and
when the carrying apparatus places the material container on the temporary storage layer, the lifting mechanism drives the bearing carrier to descend, so that the material container placed on the bearing carrier descends and engages with the suspension connector of the temporary storage layer.

8. The logistics system according to claim 1, wherein the picking apparatus comprises a conveyor and a splitting mechanism, wherein the conveyor has an input port and an output port, the carrying apparatus is capable of docking with the input port and depositing the at least two material containers on the conveyor; or the carrying apparatus is capable of docking with the output port and retrieving the at least two material containers from the conveyor;
wherein the splitting mechanism is configured to split the at least two material containers that are stacked to be arranged along a conveying direction of the conveyor, or stack the at least two material containers that are arranged along the conveying direction of the conveyor.

9. The logistics system according to claim 8, wherein the conveyor comprises an input section, a sorting section, and an output section, wherein the input section and the output section are connected to two ends of the sorting section respectively; and there are at least two splitting mechanisms, wherein the at least two splitting mechanisms are disposed on the input section and the output section respectively.

10. The logistics system according to claim 8, wherein the splitting mechanism comprises a box and a lifting mechanism, wherein the box is disposed above the conveyor and defines a lifting passage above the conveyor, and the lifting mechanism is movably disposed on an inner wall of the box, and the lifting mechanism is configured to drive the material container that enters the lifting passage to ascend or descend in the vertical direction.

11. The logistics system according to claim 1, wherein the picking apparatus comprises a conveyor, an input bracket, and an output bracket, wherein the conveyor has an input port and an output port, the input bracket is disposed at the input port, and the output bracket is disposed at the output port;
wherein the carrying apparatus is capable of docking with the input bracket and sequentially depositing the at least two material containers into the input bracket; or the carrying apparatus is capable of docking with the output bracket and sequentially retrieving the at least two material containers from the output bracket.

12. The logistics system according to claim 11, wherein the input bracket comprises two first guide members, the two first guide members are disposed parallel to each other on opposite sides of the input port, and the two first guide members are inclined relative to the horizontal direction; the output bracket comprises two second guide members, the two second guide members are disposed parallel to each other on opposite sides of the output port, and the two second guide members are inclined relative to the horizontal direction;
wherein an inclination direction of the two first guide members is opposite to an inclination direction of the two second guide members.

13. A logistics system control method, applied to the logistics system according to claim 1 and comprising:
determining positions of two target material containers at a temporary storage layer of a rack;
controlling a carrying apparatus to sequentially retrieve the two target material containers; and
controlling the carrying apparatus to simultaneously transport the two target material containers to a picking apparatus.

14. The logistics system control method according to claim 13, wherein the controlling a carrying apparatus to sequentially retrieve the two target material containers specifically comprises:
controlling the carrying apparatus in a no-load state to move to a first temporary storage position in which a first target material container is located;
controlling the carrying apparatus to lift the first target material container by a first distance;
controlling the carrying apparatus to move to a second temporary storage position in which a second target material container is located, so that the second target material container is located above the first target material container; and
controlling the carrying apparatus to lift the first target material container, so that a top surface of the first target material container abuts against a bottom wall of the second target material container, and driving the second target material container to ascend by a second distance.

15. The logistics system control method according to claim 13, wherein after the controlling the carrying apparatus to simultaneously transport the two target material containers to a picking apparatus, the method further comprises:
controlling the picking apparatus to sort goods in the target material containers; and
controlling the carrying apparatus to retrieve two sorted material containers from the picking apparatus and transport the two sorted material containers to the temporary storage layer of the rack.

16. The logistics system control method according to claim 15, wherein the controlling the carrying apparatus to retrieve two sorted material containers from the picking apparatus and transport the two sorted material containers to the temporary storage layer of the rack comprises:
controlling the carrying apparatus to transport a first sorted material container to a first control temporary storage position; and
controlling the carrying apparatus to transport a second sorted material container to a second control temporary storage position; wherein the first sorted material container is stacked above the second sorted material container.

17. A logistics system, comprising:
a warehousing apparatus comprising a plurality of warehousing layers and at least one temporary storage layer, wherein the plurality of warehousing layers are arranged along a vertical direction, the plurality of warehousing layers are configured to store a material container, the at least one temporary storage layer is arranged at the bottom of the plurality of warehousing layers, and a first moving channel is formed under the temporary storage layer;
a picking apparatus configured to sort goods that are in the material container; and
a carrying apparatus configured to transport at least two material containers simultaneously between the temporary storage layer and the temporary storage layer, and the at least two material containers simultaneously transported by the carrying apparatus are stacked in the vertical direction when being carried by the carrying apparatus.

18. The logistics system according to claim 17, wherein the picking apparatus comprises a conveyor and two splitting mechanisms;
wherein the conveyor has an input port and an output port, the carrying apparatus is capable of docking with the input port and depositing the at least two material containers on the conveyor, or the carrying apparatus is capable of docking with the output port and retrieving the at least two material containers from the conveyor;
wherein one of the two splitting mechanisms is arranged on the input port, and is configured to split the at least two material containers that are stacked to be arranged along a conveying direction of the conveyor; and
wherein the other one of the two splitting mechanisms is arranged on the output port, and is configured to stack the at least two material containers that are arranged along the conveying direction of the conveyor.

19. The logistics system according to claim 17, wherein the picking apparatus comprises a conveyor, an input bracket, and an output bracket;
wherein the conveyor has an input port and an output port, the input bracket is disposed at the input port, and the output bracket is disposed at the output port;
wherein the carrying apparatus is capable of docking with the input bracket and sequentially depositing the at least two material containers into the input bracket; and
wherein the carrying apparatus is capable of docking with the output bracket and sequentially retrieving the at least two material containers from the output bracket.

20. The logistics system according to claim 17, wherein the warehousing apparatus comprises a plurality of suspension connectors, wherein the plurality of suspension connectors are connected to a bottom of a lowest-level warehousing layer among the plurality of warehousing layers, and the plurality of suspension connectors are spaced at intervals along a length direction of the warehousing apparatus;
wherein adjacent suspension connectors define a temporary storage position, the temporary storage position is configured to store at least one material container, and the at least one material container in the temporary storage position is suspended on the adjacent suspension connectors.
